(19) United States
(12) Patent Application Publication
(10) Pub. No.: US 2008/0123036 A1
(43) Pub. Date: May 29, 2008

(54) LIQUID CRYSTAL DISPLAY DEVICE AND MANUFACTURING METHOD THEREOF

(75) Inventors: Yoichi SASAKI, Kawasaki (JP); Teruaki Suzuki, Kawasaki (JP); Mitsuhiro Sugimoto, Kawasaki (JP); Chikaaki Mizoguchi, Izumi (JP); Hiromitsu Tanaka, Izumi (JP)

Correspondence Address: YOUNG & THOMPSON, 209 Madison Street, Suite 500, ALEXANDRIA, VA, 22314, US

(73) Assignee: NEC LCD TECHNOLOGIES, LTD., Kawasaki (JP)

(21) Appl. No.: 11/944,473

(22) Filed: Nov. 23, 2007

(30) Foreign Application Priority Data
Nov. 24, 2006 (JP) 2006-316590

(51) Int. Cl. G02F 1/1337

(52) U.S. Cl. 349/124; 430/20

(57) ABSTRACT

A manufacturing method of the present invention is applied to manufacture of a liquid crystal display device comprising an array board, an opposing board opposing the array board, and a liquid crystal layer interposed between the pair of boards. The method includes a step of performing alignment processing on an alignment film formed on the surface of at least one of the pair of boards in contact with the liquid crystal. The alignment processing is performed by irradiating energy having an anisotropy such as ion beams to the alignment film in a plurality of steps while the energy intensity is set to be lowest in the final irradiation step.

This application is based upon and claims the benefit of priority from Japanese patent application No. 2006-316590, filed on Nov. 24, 2006, the disclosure of which is incorporated herein in its entirety by reference.

### BACKGROUND OF THE INVENTION

1. Field of the Invention

The present invention relates to a liquid crystal display device and a manufacturing method thereof.

2. Description of the Related Art

Liquid crystal display devices have gained popularity for their features of thin profile and light weight, and their field of application has been expanded. For example, they are now used not only as display devices for information processing terminals but also display devices for various types of industrial equipment, on-vehicle equipment such as car navigation systems, and as display devices for medical or broadcast equipment. Along with the expansion of their field of application, higher display quality is demanded for the liquid crystal display devices.

A TN (twisted nematic) method generating an electric field between a drive board and an opposing board is widely used as a drive method for a liquid crystal display panel that is one of principal elements of a liquid crystal display device. In the TN technology, however, liquid crystal molecules are aligned upright from the in-plane direction of the boards, which causes deviation in the angle of polarization as the angular field of view is increased. Accordingly, high image quality cannot be obtained when an angular field of view is wide. Due to this problem, employment of a lateral electric field method called IPS (in-plain switching) or FFS (fringe field switching) method is now being increased, in which an electric field is generated in the in-plane direction of the board to rotate liquid crystal molecules in the in-plane direction, whereby the dependency of image quality on the angular field of view is decreased.

On the other hand, as the image quality has been improved by development of various liquid crystal driving methods, minor leakage of light due to scratches or the like caused by a rubbing method conventionally employed as an alignment processing method has become not negligible. In addition, scraps from an alignment film which are produced during rubbing processing and remains in a slight amount after cleaning are viewed as a problem in some cases since these scraps may cause bright spots or blotches when vibration or heat is applied to the liquid crystal panel.

Non-contact alignment methods are actively studied for the purpose of minimizing these problems of the rubbing method and improving the image quality and reliability. For example, Patent Reference 1 (Japanese Patent No. 3229281) discloses a technique to align liquid crystal molecules by applying a particle beam to a surface of an alignment film formed by a dry film formation method. The use of the non-contact alignment technique eliminates scratches that might otherwise be generated by the rubbing processing, and homogeneous image quality can be obtained in a black tone screen or a halftone screen near the black tone.

Patent Reference 2 (Japanese Patent No. 3738990) discloses a technique in which an orientation angle or pretilt angle of liquid crystal is controlled by subjecting an alignment film formed of an organic or inorganic film to multiple irradiations of ion beams from different directions. According to Patent Reference 2, a liquid crystal display device, which is composed of cells formed between glass boards, and liquid crystal molecules held therebetween, is given orientation characteristic by subjecting an alignment film formed on the glass boards to multiple irradiations by irradiating ion beams from different directions. The multiple irradiations are conducted as shown in FIGS. 1A to 1D.

As shown in FIGS. 1A to 1D, a glass board 91 comprising an alignment film 92 formed thereon is conveyed by a conveyor (not shown) in the direction from X to Y in FIG. 1A (FIG. 1A). During this conveyance, a first ion beam from an ion beam gun 93 is irradiated to the moving alignment film 92 at a certain irradiation angle (FIG. 1B). Subsequently, the irradiated glass board 91 is conveyed in the direction from Y to X in FIG. 1C. A second ion beam is irradiated by an ion beam gun 94 to the alignment film 92 being conveyed, that is, the alignment film 92 irradiated with the first ion beam, from a different direction and at a different amount of irradiation from the first ion beam (FIG. 1C). As a result, an aligned layer 95 is formed in the alignment film 92 (FIG. 1D). The irradiation direction and irradiation amount of the second ion beam can be selected to obtain selectively controlled orientation angle or pretilt angle.

In Patent Reference 2, page 10, paragraphs [0047] and [0048], the irradiation amount Ex is represented as Ex=C×Ig×Vg÷Vst, where C is a constant, Ig denotes ion generation current, Vg denotes grid voltage of the ion beam gun, and Vst denotes conveyor stage speed.

Further, Patent Reference 3 (Japanese Laid-Open Patent Publication No. 2005-70788) discloses a technique to cover the disadvantage of the non-contact alignment technique that the orientation regulating force is lower than the rubbing method, by conducting non-contact alignment processing after conducting rubbing processing. This Patent Reference claims that when an ion beam irradiation method or the like is used in combination with the rubbing method, particularly, a high-quality liquid crystal display device can be obtained having advantages from the both methods.

### Problems Relating to Single Irradiation

The technique disclosed in Patent Reference 1 is that alignment processing is performed by single irradiation of a particle beam. However, this technique has a problem that it is difficult to provide orientation regulating force required for a real device with single irradiation of a particle beam. In a liquid crystal display device employing the IPS method, in particular, insufficient orientation regulating force is apt to cause afterimages or irregular images when the liquid crystal display device is operated for a long period of time.

The orientation regulating force can be improved by a method of increasing the irradiation speed of particles to the board surface or a method of increasing the amount of particles irradiated to the alignment film surface. However, using the method of increasing the irradiation speed of particles, the roughness on the alignment film surface may be increased to make the orientation of the liquid crystal molecules unstable, or only the alignment film surface may be etched away but the orientation regulating force cannot be improved as desired. Using an Ar ion beam, for example, Ar atoms have a diameter of about 3.64 Angstroms, while in a typical organic film a bond length between adjacent atoms composing the organic film is about 1.5 Angstroms. Therefore, the diameter of the Ar atoms is greater than the bond length. If ionized Ar particles are irradiated to the alignment film surface at high speed, this may possibly affect not only the interatomic bonds but also the atoms themselves composing the alignment film. It is difficult to selectively cut the interatomic bonds under such situation, and thus the orientation regulating force cannot be improved.

On the other hand, in order to enhance the orientation regulating force while keeping the irradiation speed of particles low, it is necessary to irradiate them for a long period of time. However, it is also problematic to increase the irradiation amount of particles. A first problem is that prolonged irradiation of particles to the board surface will increase the temperature of the board surface, making it difficult to control the process. A second problem is that when an alignment film is formed using an organic film formed by a printing method, molecules in the vicinity of the interface with gas are prealigned by the effect of the interface, and such a layer cannot be removed if processing is conducted without increasing the irradiation speed of particles, and the orientation regulating force may not be improved in a predetermined orientation direction. The orientation of these liquid crystal molecules in the vicinity of the interface does not pose any problem in the rubbing method in which the molecules are mechanically realigned, but poses a serious problem in the non-contact alignment technique in which a particle beam is irradiated to form an aligned layer on the alignment film surface. It can be concluded from the above that it is difficult to obtain sufficient orientation regulating force with a single irradiation of a particle beam.

### Problems Relating to Multiple Irradiations

Patent Reference 2 discloses a non-contact alignment technique in which the orientation angle and pretilt angle of liquid crystal molecules are controlled by multiple irradiations of first and second ion beams (particle beams). According to the non-contact alignment technique, orientation characteristic of liquid crystal is determined based on the magnitude of energy of particles acting on the alignment film and the amount of particles. In order to improve the orientation regulating force, the irradiation amount of particles or the irradiation speed of the particles must be increased. However, even if different amount of particles with a same energy are irradiated multiple times to the alignment film surface like Patent Reference 2, it will affect the direction of alignment but the phenomena occurring in the vicinity of the alignment film surface will basically remain the same. Accordingly, even if multiple irradiations are conducted while changing the irradiation amount of particles, the improvement in the orientation regulating force will be limited for the same reason as Patent Reference 1.

Additionally, according to Patent Reference 2, ion beams are irradiated in different irradiation directions for controlling the orientation angle. The orientation of the liquid crystal molecules is affected by the direction of the second ion beam irradiation in the initial state. However, when the direction of the first ion beam irradiation is not parallel with the direction of the second ion beam irradiation as shown in FIG. 4 of Patent Reference 2, the orientation regulating force of the liquid crystal molecules in the direction of the second ion beam irradiation is affected by the direction of the first ion beam irradiation. As a result, the orientation regulating force becomes lower in comparison when the second ion beam irradiation is solely conducted. In view of these problems, it is difficult for the method of Patent Reference 2 to realize sufficient improvement of the orientation regulating force on a real device.

### Problems Relating to Other Approaches

Patent Reference 3 discloses a technique to take advantages of the non-contact alignment technique while making up the shortage of orientation regulating force by employing the non-contact alignment technique after forming an alignment film through the rubbing method. However, even if the ion beam irradiation method is conducted after the rubbing processing like Patent Reference 3, scratches produced during the rubbing processing will affect also after the ion beam irradiation. Further, scraps from the alignment film produced during the rubbing processing cannot be removed completely by cleaning after the rubbing processing. Such scraps may obstruct ion beams irradiated, causing faulty orientation, or may remain in the liquid crystal cells to cause failure when vibration or heat is applied thereto.

### SUMMARY OF THE INVENTION

In view of the problems as described above, it is an exemplary object of the present invention to provide a liquid crystal display device with high image quality and high reliability by forming an aligned layer having sufficient orientation regulating force with the use of a non-contact alignment technique.

It is another exemplary object of the present invention to provide a manufacturing method of such a liquid crystal display device.

According to a first aspect of the present invention, a manufacturing method of a liquid crystal display device is provided. The liquid crystal display device comprises a pair of boards opposing to each other and a liquid crystal layer interposed between the pair of boards. The manufacturing method comprises a step of performing alignment processing on an alignment film formed on the surface of at least one of the pair of boards in contact with the liquid crystal layer. The alignment processing is performed by irradiating energy having an anisotropy to the alignment film in a plurality of steps while the energy intensity is set lowest in the final irradiation step.

In the step of performing the alignment processing, particles extracted from plasma are irradiated to the alignment film.

In the step of performing the alignment processing, it is desirable that ion beams having different acceleration energy levels are irradiated.

In the step of performing the alignment processing, the energy may be irradiated from the same direction in all the plurality of irradiation steps.

In the step of performing the alignment processing, the irradiated energy may be light.

It is desirable that the energy of light irradiated in the step of performing the alignment processing is determined by its wavelength, and the light wavelength is set to be longest in the final irradiation step.

According to a second aspect of the present invention, a liquid crystal display device comprising a pair of boards facing each other and a liquid crystal layer interposed between the pair of boards is provided. The device further comprises an alignment film formed on at least one of the pair of boards. The alignment film comprises a real-aligned layer located in contact with the liquid crystal layer and having an anisotropy of molecular chains or molecular bonds along the in-plane direction and a quasi-aligned layer located under the real-aligned layer and having a different anisotropy of molecular chains or molecular bonds along the in-plane direction from the anisotropy of the real-aligned layer.

In the liquid crystal display device, it is desirable that the alignment film contains conjugated double bonds, and the density of conjugated double bonds in the real-aligned layer is lower than the density of conjugated double bonds in the quasi-aligned layer.

In the liquid crystal display device, it may that the alignment film contains conjugated double bonds, and the anisotropy of the conjugated double bonds of the real-aligned layer along the in-plane direction is higher than that of the quasi-aligned layer.

In the liquid crystal display device, the alignment film maybe an organic film.

In the liquid crystal display device, the alignment film may comprise imide bonds.

In the liquid crystal display device, the liquid crystal layer may be driven by a lateral electric field method.

A liquid crystal display device according to the present invention is provided with enhanced liquid crystal orientation regulating force by performing non-contact alignment processing in production of a liquid crystal panel by irradiating energy having anisotropy with respect to the orientation of the liquid crystal to an alignment film surface in a plurality of steps using an irradiation method of particle or light beams, and irradiating the beam with the lowest energy intensity in the final irradiation step. As a result, the liquid crystal display device is allowed to have improved afterimage characteristic and contrast characteristic.

### BRIEF DESCRIPTION OF THE DRAWINGS

FIGS. 1A to 1D are for explaining alignment processing steps conducted by multiple irradiations of ion beams to an alignment film according to a related art;

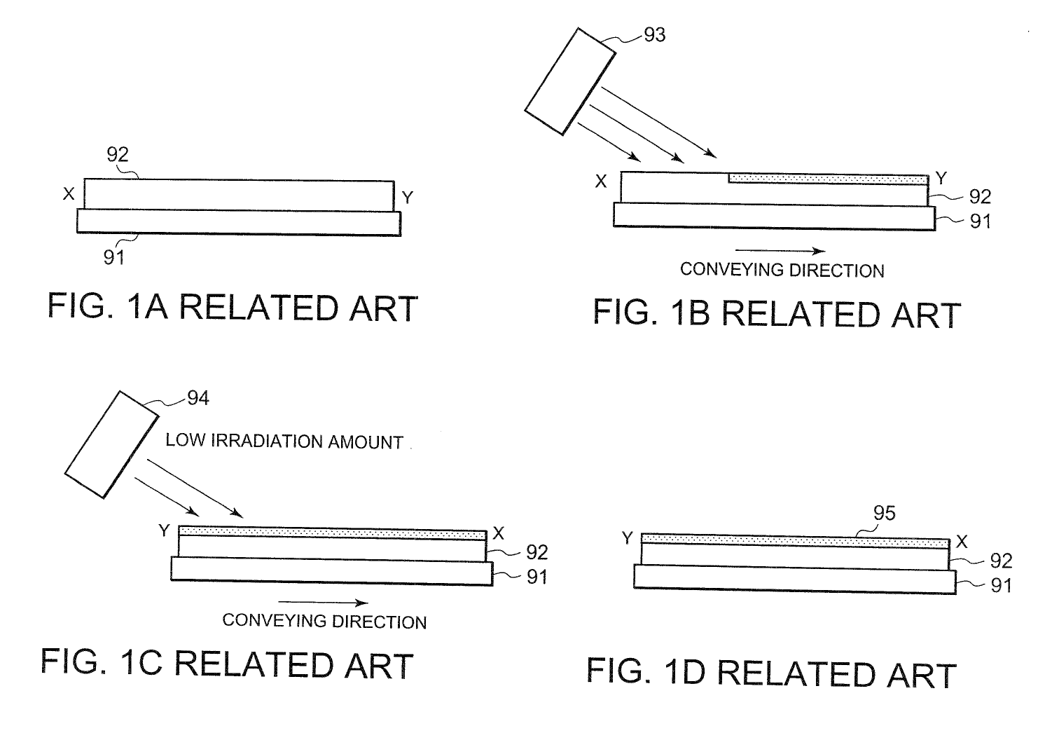

FIGS. 2A to 2F are diagrams for explaining processing steps for forming an aligned layer by several steps of energy irradiation according to the present invention;

FIG. 3 is a cross-sectional view for explaining the aligned layer formed by the processing steps illustrated in FIGS. 2A to 2F;

FIG. 4 is a process flow chart for explaining manufacturing steps for an array board and an opposing board opposing thereto of the liquid crystal display device according to the present invention;

FIGS. 5A to 5E are diagrams for explaining alignment processing steps by ion beam irradiation employed by a first embodiment of the present invention;

FIG. 6 is a diagram illustrating results of measuring the contrast ratios of the liquid crystal panel according to the first embodiment of the present invention and of liquid crystal panels according to a plurality of comparative examples;

FIG. 7 is a diagram illustrating results of measuring afterimage characteristic of the liquid crystal panel according to the first embodiment of the present invention and liquid crystal panels according to a plurality of comparative examples;

FIG. 8 is a diagram illustrating results of measuring the contrast ratio and afterimage characteristic of a liquid crystal panel according to a second embodiment of the present invention;

FIGS. 9A to 9D are diagrams illustrating relation between processing time and irradiated energy in the alignment processing steps employed by the present invention; and

FIG. 10 is a cross-sectional view showing principal components of the liquid crystal display device according to the present invention.

### DESCRIPTION OF THE PREFERRED EMBODIMENTS

Preferred embodiments of the present invention will be described with reference to the accompanying drawings.

The present invention is characterized by enhancing the orientation regulating force for liquid crystal by conducting non-contact alignment processing in production of a liquid crystal panel by irradiating energy having anisotropy with respect to the orientation of the liquid crystal to an alignment film surface in a plurality of steps using an irradiation method of particle or light beams, and irradiating the beam with the lowest energy intensity in the final step of irradiation. The present invention is thus capable of improving the afterimage characteristic and contrast characteristic of the liquid crystal display device.

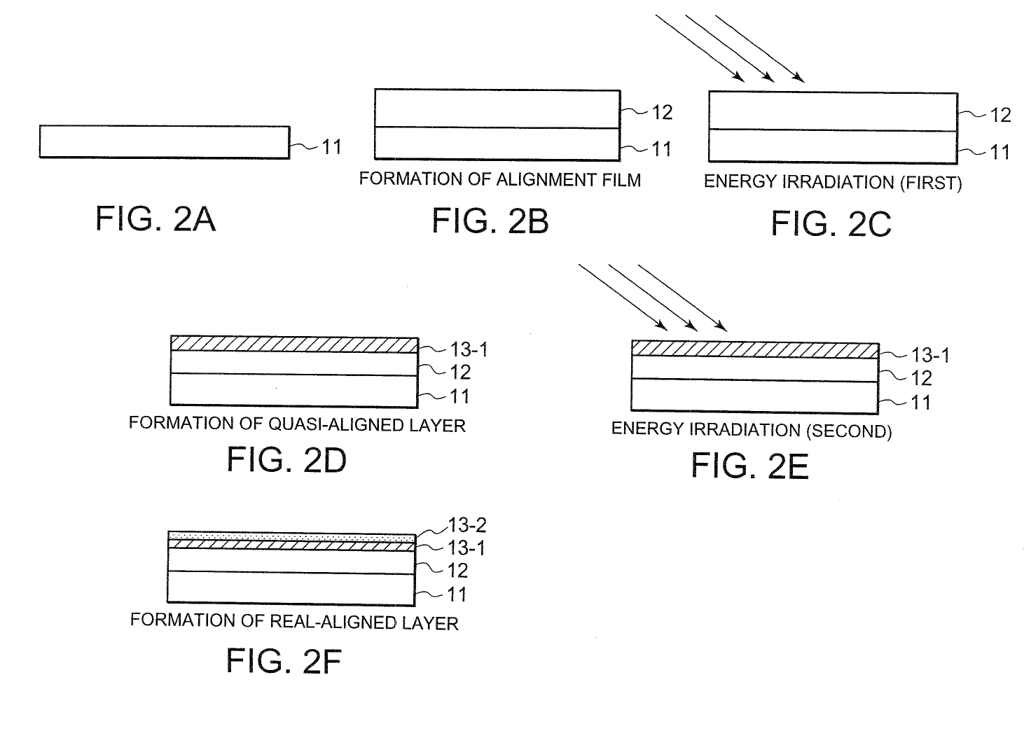

Referring to FIGS. 2A to 2F, description will be made of a case in which the present invention is applied to a liquid crystal display device comprising a board pair consisting of an array board and an opposing board, and liquid crystal held between the board pair. FIGS. 2A to 2F sequentially illustrate alignment processing steps performed on an alignment film formed on the inner side of the array board and opposing board, namely on their surfaces in contact with the liquid crystal. Since the alignment processing for the array board is the same as that for the opposing board, the following description will be made of the case of the array board.

An array board 11 (or opposing board) shown in FIG. 2A is formed thereon with an alignment film 12 by a predetermined method (FIG. 2B), and then energy having anisotropy along the orientation of the liquid crystal is irradiated in a plurality of steps to the alignment film 12 being conveyed. In the example illustrated herein, the energy irradiation is performed in two steps as shown in FIG. 2C and 2E. Specifically, in the first energy irradiation shown in FIG. 2C, energy is irradiated to the alignment film 12 being conveyed from a certain direction, whereby a quasi-aligned layer 13-1 is formed on the alignment film 12 as shown in FIG. 2D. Subsequently, as shown in FIG. 2E, while the array board 11 comprising the quasi-aligned layer 13-1 formed thereon is conveyed in the same direction as in FIG. 2C, the second energy irradiation is performed from the same direction as FIG. 2C. As a result, a real-aligned layer 13-2 is formed on the quasi-aligned layer 13-1 (FIG. 2F). As described later, the second energy irradiation may be performed after rotating the array board 11 180 degrees with respect to the surface direction of the board.

As mentioned in the above, the intensity of the energy to be irradiated is set to be lowest in the final irradiation step. Specifically, the energy intensity in the step of FIG. 2E is set lower than that in the step of FIG. 2C.

The term “energy” as used herein refers to X-rays, electron beams, UV light, or particles having a speed in one direction such as ion beams extracted and accelerated from plasma by voltage, which affect molecular bonds or electronic state of the alignment film upon reaching the alignment film. In the case of particles, the magnitude of the energy intensity can be changed by varying the acceleration energy or the relative angle to the board. When the acceleration condition is the same, the magnitude of the energy intensity depends on the mass of the particles. In the case of UV light or the like, the energy intensity can be changed by varying the wavelength or the angle of incidence.

The plurality of energy irradiation steps may be performed either by using separate and independent irradiation units, or by using a single irradiation unit in common. In the latter case, both high energy and low energy may be irradiated in one step by modulating the energy intensity on the single irradiation unit.

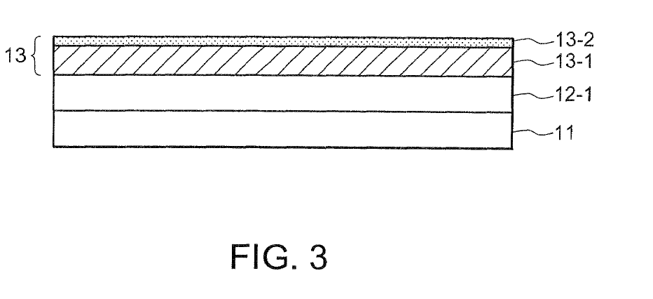

The alignment processing performed by the plurality of energy irradiation steps forms an aligned layer 13 consisting of a real-aligned layer 13-2 and a quasi-aligned layer 13-1 on the alignment film 12 as shown in FIG. 3. There may be a randomly-aligned layer 12-1 that is substantially not aligned at all, under the aligned layer 13.

As described above, a quasi-aligned layer is formed in the initial energy irradiation step, and a real-aligned layer is formed on the quasi-aligned layer in a later energy irradiation step. The energy irradiation at high energy intensity in the former step acts on the real-aligned layer and quasi-aligned layer to a deeper position from the alignment film surface, and the energy irradiation at low energy intensity in the later step acts on them to a shallower position than that. These layers may have different molecular bond states or different degrees of anisotropy of molecular chains or molecular bonds.

The real-aligned layer has higher anisotropy along the orientation direction in the in-plane direction parallel to the board surface than the quasi-aligned layer. The real-aligned layer is in direct contact with the liquid crystal molecules to align the liquid crystal molecules. The term “molecular bond state” as used herein refers to an interatomic bond such as a carbon-to-carbon a bond or π bond, or a molecular bond, including a bond between different atoms. The quasi-aligned layer stabilizes the anisotropy of molecules of the real-aligned layer and partially contributes to the alignment of the liquid crystal.

The term “real-aligned layer” as used in the present invention refers to a layer which is formed by energy irradiation in the initial and final steps of the plurality of energy irradiation steps, being located in the vicinity of the alignment film surface, and which has the highest anisotropy of molecular chains in the alignment film and is in contact with the liquid crystal to contribute to alignment of the liquid crystal. The term “quasi-aligned layer” refers to a layer which is formed in a step prior to the final energy irradiation step, being located in a deeper region from the alignment film surface than the real-aligned layer, and which has lower degree of orientation of molecular chains than the real-aligned layer.

In order to enhance the orientation regulating force, the alignment film molecules should be oriented with even higher anisotropy. For realizing this purpose using the irradiation method of particle beams, the molecular chains present in random directions must be cut in one direction with particles having high energy intensity within a certain level. However, the energy particles with high energy intensity have low selectivity when acting on the molecular bonds, and hence may cause unstable interaction between the liquid crystal molecules and the alignment film surface. It may cause disorder in the liquid crystal in the vicinity of the interface of the alignment film, leading to deterioration of the orientation regulating force.

According to the approach of the present invention, these phenomena are suppressed by performing an energy irradiation with low energy intensity in combination with and after an energy irradiation with high energy intensity. The energy particles with low energy intensity have high selectivity to an object to act on. Therefore, if conditions are selected appropriately, such energy particles will not only improve the anisotropy of bonds contributing to alignment of the liquid crystal but also correct any roughness caused by the irradiation of energy particles with high energy intensity. Such combination of energy irradiation with high energy intensity and that with low energy intensity provides a desirable orientation characteristic, enabling improvement of optical characteristics such as contrast and reliability characteristics such as afterimage. Further, when the irradiation method of particles to the alignment film surface in order to further improve in the step of energy irradiation at low energy intensity the anisotropy of the alignment film which has been generated by the energy irradiation at high energy intensity, the direction of energy irradiation at high energy intensity is desirably parallel with the direction of energy irradiation at low energy intensity, and more desirably the directions are the same.

### First Embodiment

Description will be made of an example of alignment processing in two steps using Ar ion beams with different energy intensities. An alignment film of polyimide is formed on an array board comprising a thin-film transistor, an electrode for applying electric field to liquid crystal molecules in the in-plane direction of the board (lateral electric field mode), and an electrode for electrically connecting them. An alignment film of polyimide is also formed on an opposing board formed with a black matrix layer, an RGB color layer, an overcoat layer, and a columnar spacer. Alignment processing is conducted on each of the alignment films formed on the boards. In this alignment processing step, Ar ion beams having anisotropy along the orientation direction of the liquid crystal are irradiated onto the alignment film in two steps. The energy intensity of the irradiated Ar ions is set such that the energy intensity is lower in the second irradiation step that is conducted in sequence to the first irradiation step than in the first irradiation step. The energy intensity is changed by changing the acceleration energy of the Ar ions.

A quasi-aligned layer is formed in the first irradiation step, and a real-aligned layer is formed on the quasi-aligned layer in the second irradiation step. A randomly-aligned layer may be present under the quasi-aligned layer in the alignment film. This is because the Ar ion beams do not reach the lowermost layer of the alignment film if the alignment film has a thickness of several hundred Angstroms or more. The number of carbon-to-carbon conjugated double bonds per unit area is the greatest in the randomly-aligned layer, next greatest in the quasi-aligned layer, and least in the real-aligned layer. On the other hand, the anisotropy along the orientation direction of these bonds is higher in the real-aligned layer than in the quasi-aligned layer.

### (Description of Manufacturing Method)

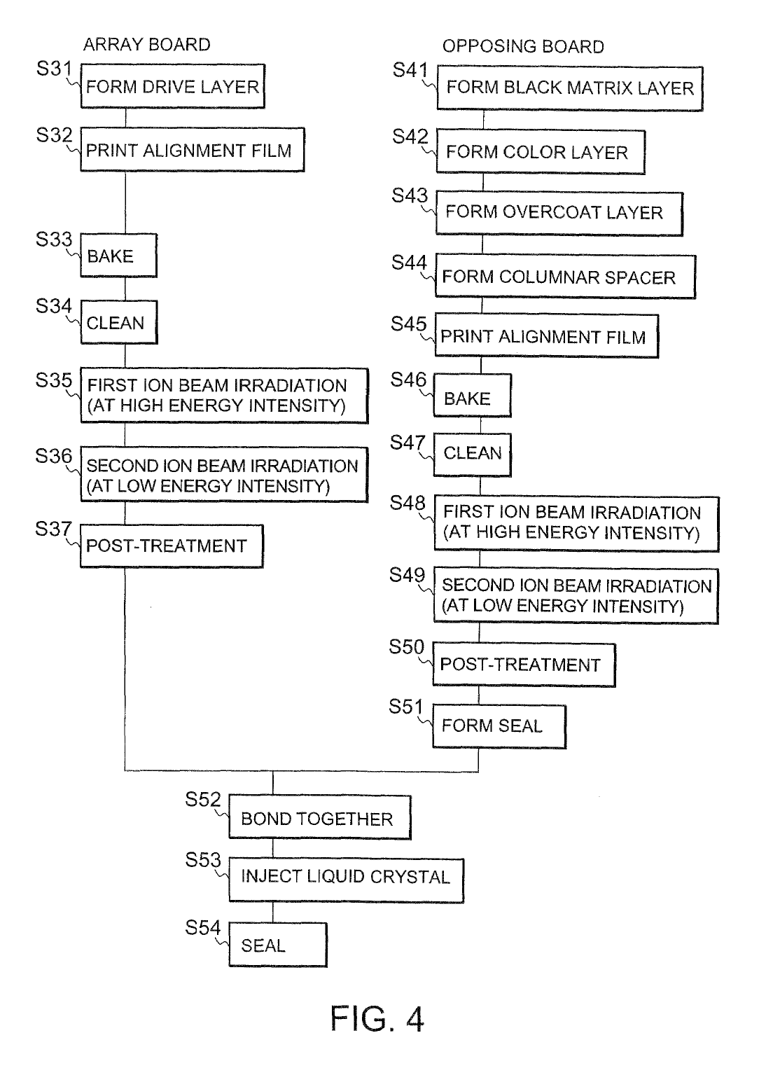

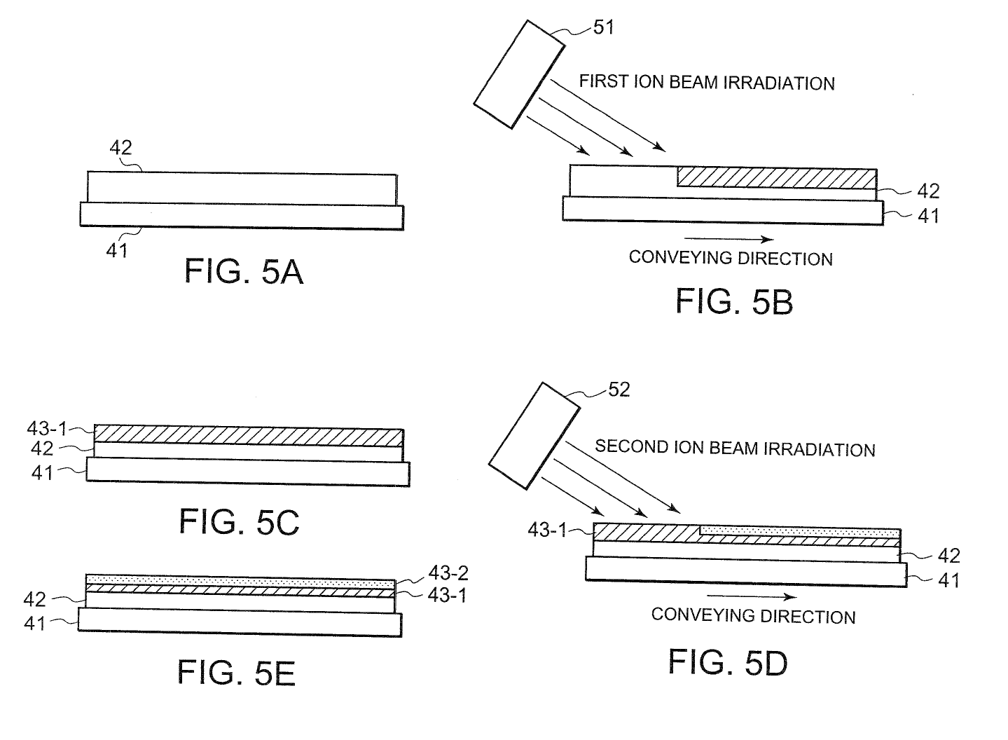

A manufacturing method of the liquid crystal display device according to the present invention will be described with reference to FIG. 4 and FIGS. 5A to 5E. FIG. 4 shows a process flow chart illustrating processing steps to obtain a liquid crystal panel, and FIGS. 5A to 5E schematically show respective steps of alignment processing in which ion beams are irradiated in two stages.

An array board comprising a liquid crystal drive layer of the in-plane switching type formed on a glass board is prepared (S31 in FIG. 4) and an opposing board comprising a black matrix layer, an RGB color layer, an overcoat layer, and a columnar spacer formed on a glass board is prepared (S41,S42,S43,and S44 in FIG. 4). Polyimide dissolved in an organic solvent is flexographically printed on each of the array board and the opposing board (S32 and S45 in FIG. 4). The solvent is evaporated on a hot plate, and then the polyimide is hardened by chemical reaction in a baking furnace controlled under a nitrogen atmosphere (S33 and S46 in FIG. 4) to form an alignment film, While an optimal board temperature during the baking depends on a type of the alignment film, the temperature is desirably from 200 to 250° C., for example 230° C. in this embodiment. The board surface may be heated by irradiation of infrared rays during the baking. Further, each of the steps of removing the solvent, baking, and cooling may be composed of a plurality of steps. The boards which have been baked are cooled, cleaned with pure water (S34 and S47 in FIG. 4), and dried with an air knife.

Subsequently, alignment processing is performed in a vacuum chamber of the ion beam irradiation device. The alignment processing is performed by irradiating ion beams to the surface of the alignment film. The ion beams are irradiated from a direction inclined by a certain angle with respect to the board surface so that the incidence angle a to the board surface is 15 degrees, for example.

A neutralizing unit is arranged within the ion beam irradiation device for generating electrons to neutralize the ion beams. Ar ions emitted by an ion beam gun are partially neutralized by the neutralizing unit to become neutral Ar atoms. The Ar ions and Ar atoms are irradiated (applied) to the board surface, and the both particles contribute to the alignment processing. Stable ion beam irradiation to the board surface can be ensured by decreasing the amount of Ar ions irradiated to the board to suppress charging of the board. The conditions such as atmospheric pressure and voltage during the ion beam irradiation may be set by employing the conditions described for example in Patent Reference 4 (Japanese Laid-Open Patent Publication No. 2004-205586). The following is an example of the conditions.

A degree of vacuum in the vacuum chamber in which the ion beams are irradiated is preferably set to an order of 10⁻² Pa when the ion beam irradiation is not performed. Thus, the degree of vacuum becomes an order of 10⁻⁴ Pa when the ion beams are irradiated in the vacuum chamber which can be kept under desirable conditions. According to this embodiment, the particle accelerating voltage is set such that the energy of the particles becomes 400 eV in the first irradiation step. In the second irradiation step, the accelerating voltage is set such that the energy of the particles becomes 200 eV.

Although the board temperature is not controlled in this embodiment, the board temperature may be controlled by using a board stage for keeping the board temperature fixed, for example at 20° C., so that the in-plane uniformity of an aligned layer formed by the ion beam irradiation is improved.

Referring also to FIGS. 5A to 5E, in this embodiment, the first irradiation step for the alignment film 42 formed on the array board (or the opposing board) 41 shown in FIG. 5A is performed by irradiating Ar ion beams having anisotropy along the orientation direction by an ion beam gun 51 with an acceleration energy of 400 eV as shown in FIG. 5B (S35 and S48 in FIG. 4). This forms a quasi-aligned layer 43-1 in the alignment film 42. Subsequently, as shown in FIG. 5C, the board comprising the quasi-aligned layer 43-1 formed thereon is continuously conveyed in the same direction under a vacuum. As shown in FIG. 5D, the second irradiation step is performed by irradiating ion beams having an acceleration energy of 200 eV to the board by an ion beam gun 52 from the same direction as in the first irradiation step (S36 and S49 in FIG. 4). The amount of irradiation in the second irradiation step is set to be a half of the amount of irradiation in the first irradiation step. As a result, as shown in FIG. 5E, a real-aligned layer 43-2 is formed on the quasi-aligned layer 43-1. The directions to irradiate ion beams to the array board and the opposing board are set such that antiparallel orientation is established when they are assembled into a liquid crystal panel of a liquid crystal display device. After completing the ion beam irradiation in the second irradiation step, the board is conveyed further in the vacuum chamber so that post-treatment is performed by irradiating hydrogen to the board (S37 and S50 in FIG. 4).

Although in the first embodiment the two ion beam guns 51 and 52 are used to irradiate ion beams with respectively predetermined acceleration energy levels, a single ion beam gun may be used to perform two beam irradiations. In this case, generation of ion beams is once stopped after the first irradiation. The board is then returned to a predetermined position in the vacuum chamber before the second beam irradiation is conducted at lower energy intensity than in the first irradiation.

The post-treatment may be conducted twice, after the first ion beam irradiation step and after the second ion beam irradiation step. It is particularly desirable to conduct the post-treatment twice when the board remains in the ion beam irradiation device for a long period of time between the first ion beam irradiation step and the second ion beam irradiation step. The board may be taken out from the ion beam irradiation device under vacuum into clean room atmosphere after the first ion beam irradiation step and before starting the second ion beam irradiation step. In this case, it is desirable to conduct the post-treatment after completing the first ion beam irradiation step and before taking the board out of the vacuum chamber. The term “post-treatment” as used herein means end processing performed to stabilize a multiplicity of unstable molecular bonds which are apt to be present in the surface of the aligned layer directly after the ion beam irradiation.

In the first embodiment, the end processing is performed using a gas mixture of hydrogen and nitrogen. Patent Reference 5 (Japanese Kohyo Patent Publication No. 2004-530790) describes an example of an end processing method using a gas mixture of hydrogen and nitrogen. Describing briefly, an end processing step is conducted by spraying the gas mixture of hydrogen and nitrogen on the board placed in an end processing unit, with the hydrogen concentration being set to 4 wt %. A filament of tungsten heated to about 1000° C. is arranged within a chamber of the end processing unit, so that bonding with unstable hydrogen is accelerated to enable formation of a stable alignment layer. The pressure in the end processing unit, like in the irradiation unit, is kept in the order of 10⁻² Pa when the spraying is not performed.

Gas of other elements or a gas mixture thereof may be used in place of the gas mixture of hydrogen and nitrogen, or water or an organic material may be sprayed. When using an organic material, the pretilt angle of the liquid crystal molecules can be reduced by using one having an appropriate polar group. The board which has been stabilized by the end processing is returned to the clean room atmosphere and passed to the next step. Further, after the ion beam irradiation step, it is desirable not to perform any wet cleaning which will wet the aligned layer with water or cleaning solvent.

The array board and opposing board comprising the aligned layer formed thereon are bonded to each other with a sealing material such that the aligned layers thereof face each other (S51 and S52 in FIG. 4), and a liquid crystal compound is loaded into a space between the boards to seal the same (S53 and S54 in FIG. 4). A liquid crystal panel is obtained in this manner.

Although the liquid crystal is loaded by an injection method according to the present embodiment, it may be instilled by using an ODF (one drop fill method). In the ODF method, the liquid crystal compound is instilled onto one of the boards coated with a sealing material. After combining the board with the other one, the sealing material is hardened to provide a liquid crystal panel. The liquid crystal panel is heated at a temperature equal to or higher than the nematic-isotropic transition temperature of the liquid crystal compound, and a polarization plate is bonded to the liquid crystal panel. Subsequently, a drive board is connected and a back light unit is assembled to provide a liquid crystal display device.

Although the orientation of the liquid crystal is antiparallel in this embodiment, it may be spray orientation. In the case of spray orientation, luminance asymmetry depending on the angular field of view is low. Therefore, the dependency of luminance and color tone on the angular field of view can be suppressed by combination with an optical compensation film. On the other hand, in the case of antiparallel orientation, the luminance as viewed from a specific direction during black display can be suppressed more effectively than in the spray orientation. Therefore, these modes of orientation should preferably be used selectively according to usage of each liquid crystal display device.

Although a preformed columnar spacer material is used in this embodiment, a spherical spacer material may be used instead. In this case, the spherical spacer material should preferably be spread over after the ion beam irradiation step.

Although a color layer is formed on the opposing board in this embodiment, no color layer may be formed if the liquid crystal display device is exclusively for monochromatic display such as a radiogram image display device. A plurality of color layers may be formed in a stack to serve also as a black matrix layer. In this case, the black matrix layer need not be formed in a separate step. Further, a columnar spacer may be formed if necessary without forming an overcoat layer on the color layer, and the processing may proceed to the alignment film formation step.

The liquid crystal display device thus fabricated was used to conduct contrast ratio measurement and afterimage tests. Additionally, besides the manufacturing method described in the first embodiment, panels were fabricated, as comparative examples 1 to 3, by conducting alignment processing with only one energy irradiation at acceleration energy of 200 eV while differing the amount of irradiation for the respective panels. Another panel was fabricated as comparative example 4 by conducting only one energy irradiation at an acceleration energy of 400 eV. Further, panels were fabricated as comparative examples 5 and 6 by conducting the energy irradiation in two stages, while setting the acceleration energy at a same value for the first and second irradiations and changing the amount of irradiation between the first and second irradiations. The contrast ratio measurement and the afterimage tests are conducted also on these comparative examples.

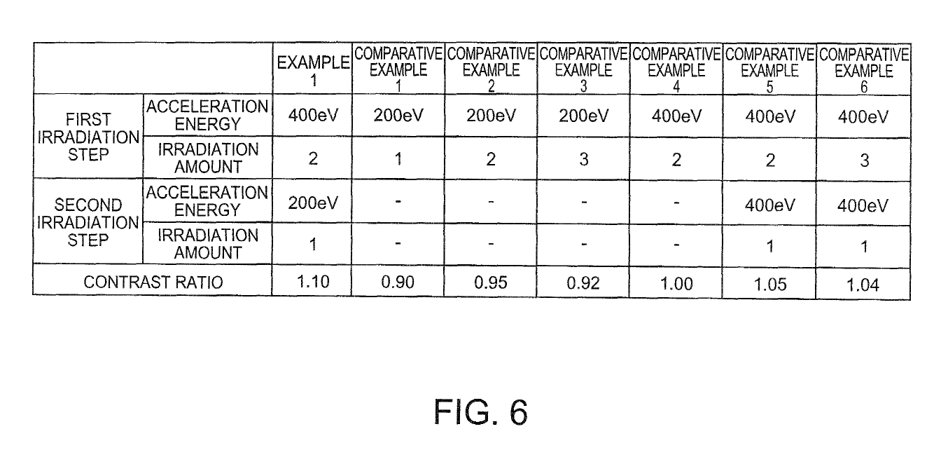

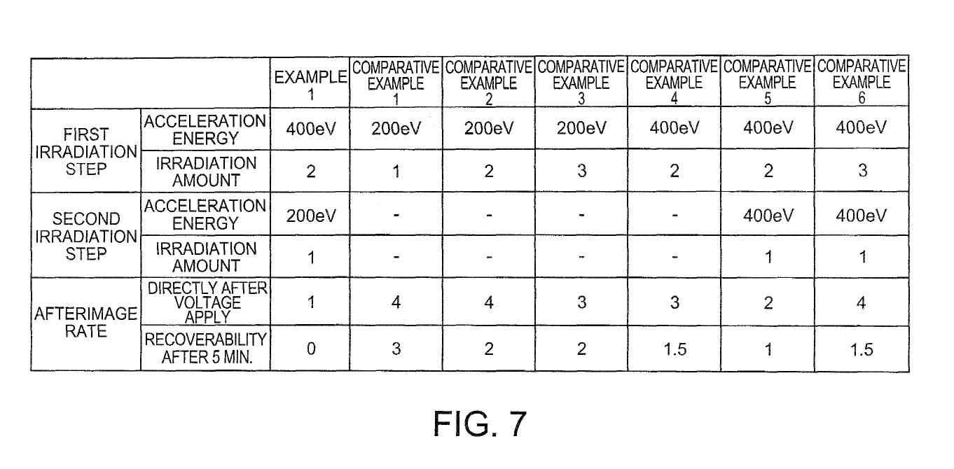

FIGS. 6 and 7 show the results of the contrast ratio measurement and the afterimage test, respectively.

The contrast ratio measurement was carried out by measuring the white and black luminance at predetermined measurement points in a display surface of each liquid crystal display device, and dividing the white luminance value by the black luminance value to obtain a contrast ratio. The measurement was performed by using a TOPCON luminance meter BM-5A. The test was conducted at nine measurement points in the display surface of each of the liquid crystal panels, and an average value thereof was obtained. The contrast ratio obtained with best conditions of a single irradiation was defined as 1, and the respective test results were expressed in FIG. 6 as ratios to 1.

According to the manufacturing method of the first embodiment, the contrast ratio was improved by 10% compared to the highest contrast ratio obtained by a single irradiation. Further, the contrast ratio obtained by the manufacturing method of the first embodiment was higher than those of the comparative examples 5 and 6 in which alignment processing was conducted with same acceleration energy but with different amounts of irradiation in the first and second irradiation steps.

The afterimage test was conducted in the following manner. The various types of liquid crystal panels were assembled into respective liquid crystal display devices, and they were held for eight hours in the state where a black and white checkered pattern was displayed on the display surface. The display was then switched to full-screen display at 128/256 gradations and left to stand for five minutes. The display device was placed in a darkroom to visually check whether afterimage of the checkered pattern was observed or not. The test was conducted under ambient temperature while back light was always kept lit during the test. The result of the visual check of the afterimage was evaluated by classifying the afterimage levels into five levels from 0 to 4. The state in which no afterimage was observed at all was defined as level 0, and the levels were increased in the sequence of 1, 2, 3 and 4 as the degree of afterimage was increased. The level 1 was defined to correspond to a state where a difference of about 1/256 gradations was observed, the level 2 a state where a difference of about 2/256 gradations was observed, the level 3 a state where a difference of about 3/256 gradations was observed, and the level 4 a state where a difference of about 4/256 gradations was observed. Practically usable afterimage levels are the level 0 or 1. When any afterimage was visually determined to be intermediate between the levels, it was defined as 0.5, 1.5, 2.5, or 3.5.

As shown in FIG. 7, the manufacturing method according to the present embodiment exhibited the lowest afterimage level and the afterimage disappeared within five minutes. Therefore, the liquid crystal panel of the present embodiment sufficiently satisfies the requirements for practical use. On the other hand, the liquid crystal panels of the comparative examples 1 to 6 do not satisfy the requirements for practical use, and their afterimage characteristics are greatly inferior to the liquid crystal panel produced by the method of the present embodiment.

The real-aligned layer and quasi-aligned layer, and the randomly-aligned layer under them can be observed clearly with a transmission electron microscope (TEM) and electron energy loss spectroscopy (EELS). An SiO₂ film was formed, as an upper protective film, without pretreatment on the array board and opposing board which have been subjected to the alignment processing, and samples for cross section observation were prepared with the use of a focused ion beam (FIB) processing device. Thereafter, transition peaks in the vicinity of the surface of the alignment film was measured by the TEM method, and those at points about 30 to 50 Angstroms and about 250 Angstroms from the alignment film surface were measured by the EELS method. The transition peak caused by carbon-to-carbon π bonds contributing to the orientation of the liquid crystal was smallest at the vicinity of the alignment film surface, next smallest at the measurement point 30 to 50 Angstroms from the alignment film surface, and greatest at the measurement point about 250 Angstroms from the alignment film surface. The magnitude of the transition peak at the point about 250 Angstroms from the alignment film surface is substantially equal to the value obtained when measuring an alignment film not subjected to alignment processing. The magnitude of transition peak is correlated with the density of π bonds, and thus it can be seen that there are three layers: a real-aligned layer, a quasi-aligned layer, and a randomly-aligned layer which is substantially not aligned at all. Non-Patent Reference 1 (Journal of the Crystallographic Society of Japan, Vol. 4, pp. 277 to 283, pp. 47 to 364) discloses one of the typical TEM and EELS measurement methods.

Although in the embodiment above the density of π bonds as one of the molecular bond states differs in the respective layers, the density of functional groups such as imide groups or carbonyl groups forming the layers may differ in the respective layers. As for the densities of functional groups in the three layers consisting of the real-aligned layer, the quasi-aligned layer and the randomly-aligned layer, the density in the real-aligned layer is the lowest among the three layers, and the density in the randomly-aligned layer is the highest.

The molecular bond state in a depth direction can also be measured by using X-ray photoelectron spectroscopy. In this embodiment, a carbon-to-carbon conjugated double bond in a depth direction is measured and the molecular bond state is determined based on a corresponding measurement peak. The measurement in a depth direction is performed by changing the angle of an incident X-ray and the angle of a detector of emitted X-ray. Alternatively, the measurement in a depth direction may be performed while etching the surface with Ar. When the measurement is conducted on a polyimide alignment film subjected to beam irradiation under the conditions according to the present embodiment while using, as a reference, an alignment film used in the present embodiment which has not been subjected to the alignment processing, the ratio compared with the peak reference derived from the conjugated double bonds varies in three stages: in a layer in the vicinity of the surface, in a layer from the surface vicinity to about 30 to 50 Angstroms from the surface, and in a layer further away from the surface. The ratio is the smallest in the surface vicinity and the greatest in the layer away from the surface, which coincides with the results of the TEM and EELS measurements.

The anisotropy of molecular chains or molecular bonds can be measured according to depth by irradiating an X-ray from a direction parallel or vertical to the direction of alignment processing and changing the angle of the incident X-ray and the angle of the detector of emitted X-ray. The anisotropy is high when the peak ratio between the parallel and vertical direction is great. The correspondence of the measured peaks to the molecular chains or molecular bonds is estimated based on the peak position. The degree of orientation is highest in the vicinity of the surface and second highest in a region from the surface vicinity to several tens of Angstroms from the surface. The peak ratio between the parallel and vertical directions is substantially 1 in a region further away from the surface, which means the region is in the substantially randomly aligned state. In the case of this embodiment, the π-bond anisotropy is highest in the vicinity of the alignment film surface, next highest at the measurement point 30 to 50 Angstroms from the alignment film surface, and lowest at the measurement point about 250 Angstroms from the alignment film surface.

Desirably, synchrotron radiation X-ray is used as the X-ray for these measurements. While measurement values of the X-ray measurement method reflect electron density distribution, the approach of examining the anisotropy of molecular chains or molecular bonds by using the X-ray measuring method is suitable for establishing the orientation process, since in the ion beam irradiation method, the anisotropy of π-electron clouds of the conjugated double bonds particularly contributes to the orientation of the liquid crystal. In order to obtain detailed data, NEXAFS (near-edge x-ray absorption fine structure) spectroscopy using synchrotron radiation X-ray may be employed.

It is confirmed based on the results described above that the liquid crystal panel manufactured by the manufacturing method of the present embodiment is superior to a liquid crystal panel manufactured by a conventional method in contrast ratio and afterimage characteristic.

In the manufacturing method of the liquid crystal panel according to the present embodiment, the non-contact alignment processing is carried by employing an ion beam irradiation method, irradiating (applying) energy having anisotropy with respect to the orientation direction of the liquid crystal to the alignment film surface in a plurality of steps, and irradiating (applying) the energy at the lowest intensity in the final step of irradiation, whereby the orientation regulating force of the liquid crystal can be enhanced, resulting in improved afterimage characteristic and contrast characteristic. These advantageous effects are obtained for the reasons as described below.

The ion beam irradiation using Ar ion beams, which is conducted in two steps by irradiating Ar ion particles to a polyimide alignment film at high acceleration energy as the first irradiation step and irradiating Ar ion particles thereto at low acceleration energy as the second irradiation step, includes a first step in which polyimide molecular chains in the vicinity of the alignment film surface is cut by the ion beam irradiation at high energy intensity to increase the anisotropy of the remaining molecular chains, and a second step in which molecular bonds such as conjugated double bonds between carbon atoms in the polyimide molecular chains are selectively cut by the beam irradiation at low energy intensity to achieve uniformity in the alignment film surface whereby the disorder in the liquid crystal molecule in the vicinity of the alignment film surface is suppressed while ensuring high degree of orientation in the in-plane direction. The combination of these first and second steps makes it possible to obtain a sufficient orientation regulating force from the real-aligned layer formed on an orientation assisting layer (quasi-aligned layer) and auxiliary orientation from the orientation assisting layer, and thus the stability in the liquid crystal orientation can be improved. As a result, a liquid crystal panel having excellent contrast ratio and afterimage characteristics can be provided. These effects are due to the fact that the orientation direction of the liquid crystal coincides with the direction of anisotropy of the orientation assisting layer formed in the first irradiation step and the direction of the anisotropy of the real-aligned layer formed in the second irradiation step by the irradiation from the same direction.

### Second Embodiment

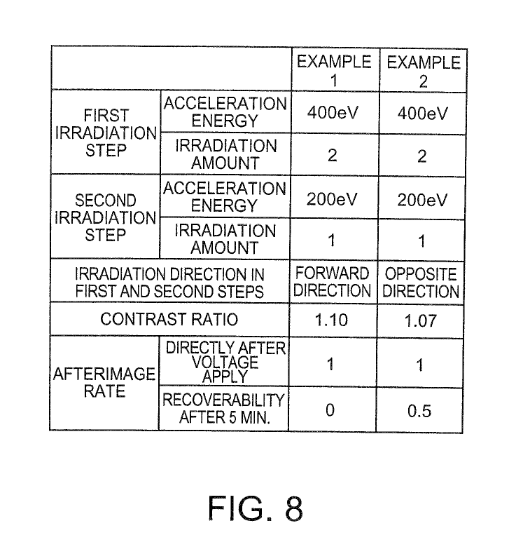

In the manufacturing method of the first embodiment (Example 1), the two-step Ar ion beam irradiation is conducted by irradiating the ion beam to the board from the same direction both in the first and second irradiations. In a second embodiment, in contrast, a step of rotating the direction of the board by 180 degrees with respect to the surface direction is inserted between the first and second irradiation steps which are conducted under the same flow conditions as in the first embodiment, so that the board is irradiated with the ion beams from the opposite directions in the first and second irradiation steps. A liquid crystal panel subjected to such alignment processing was fabricated, and the contrast ratio measurement and afterimage test were conducted thereon. The results are shown in FIG. 8 as Example 2. The contrast ratio measurement and the afterimage test were conducted in the same manner as those described in relation to the first embodiment (Example 1). As seen from the results shown in FIG. 8, Example 2 is superior to the comparative examples 1 to 6 shown in FIGS. 6 and 7 in the contrast ratio and afterimage characteristic, though inferior to Example 1, and satisfies the requirements for practical use. The practically sufficient orientation regulating force can be obtained due to the fact that the irradiation directions in the first and second irradiations are parallel to each other, and a real-aligned layer having high orientation regulating force can be formed by irradiating the beams both at high energy intensity and low energy intensity.

It is for the following reasons that Example 2 is inferior in characteristics to Example 1 in which two irradiations are conducted from the same direction. When ion beams are irradiated at an angle of 15 degrees from the horizontal direction of the board (at 75 degrees from the normal direction), the molecular bonds along the beam angle are the greatest in amount among those remaining after the beam irradiation and thus the molecular bonds forming an angle with the beam can be cut easily. On the other hand, when ion beams are irradiated in parallel, the same result can be obtained for those molecular bonds having an angle with respect to the horizontal direction of the board (the direction in which the progressing direction of the beam is projected on the board), no matter whether the beams are irradiated from the same direction or the beams are irradiated from the opposite directions. However, when first irradiation is performed at an angle of 15 degrees as described above, the second irradiation will be performed at an angle of 150 degrees if the beam is irradiated from the opposite direction. This makes it easier to cut the molecular bonds, resulting in decrease of bonds contributing to the orientation on the alignment film.

Although, in FIGS. 5A 5E, the direction to convey the board coincides with the direction when the ion beam progressing direction is projected on the board, the ion beam may be irradiated in one or all the steps such that the board conveying direction is opposite to the direction when the ion beam progressing direction is projected on the board.

Although, in the embodiments above, the alignment processing is performed by two Ar ion beam irradiation steps, particle beams may be irradiated in three or more steps. In this case, the energy intensity of the particle beams irradiated in the final step is set lower than that of the particle beams irradiated in any other steps. Further, although Ar ion beams are used as the particle beams in the embodiments, ion beams of other elements such as hydrogen, helium and neon, or plasma beams may be used instead, and ion beams of different elements may be used in the plurality of irradiation steps.

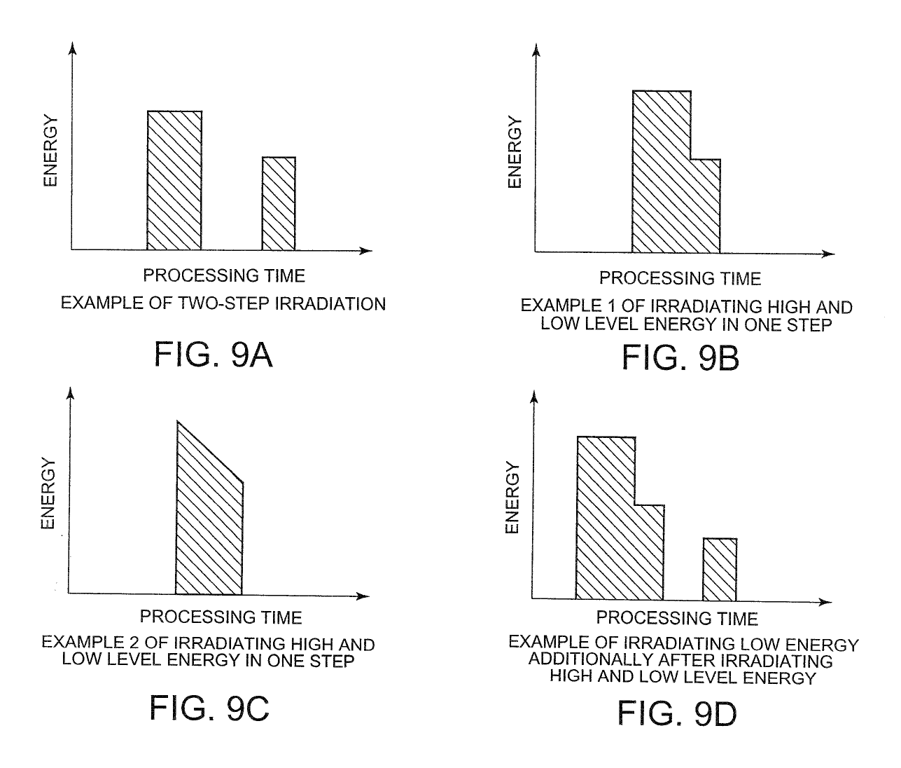

Although, in the embodiments above, the energy irradiation is performed in two steps with an interval therebetween as shown in FIG. 9A by using two ion beam irradiation units which are set so as to generate ion beams with high energy intensity and low energy intensity, respectively, the energy irradiation may be performed continuously as shown in FIG. 9B. In this case, a single energy irradiation unit may be used while modulating stepwise the intensity of the applied energy. Alternatively, using a single energy irradiation unit which is designed to be capable of simultaneously applying the energy at two different energy intensities (high and low), the board may be conveyed so that the board is passed sequentially through a region irradiated with energy beams of high energy intensity and a region irradiated with energy beams of low energy intensity. Furthermore, it suffices if the energy intensity is lowest in the final irradiation step, and hence the energy intensity may be modulated continuously as shown in FIG. 9C. These approaches may be combined, and for example the energy irradiation as shown in FIG. 9D is possible by combining the energy irradiation methods of FIGS. 9A and 9B.

Although the acceleration energy is mentioned before as an example of means for changing the energy intensity, the energy intensity may be changed by way of the angle of incidence of the beam or the mass of particles.

Although polyimide was used as the most suitable material for the alignment film in the embodiments above, any other organic or inorganic film formed by a wet film formation method may be used as the alignment film. For example, the alignment film may be an organic film of acrylic resin, aromatic polyamide resin, styrene resin, aromatic ether resin, polyacetylene resin, or a derivative or mixture thereof, and an organic film of a polymeric resin which is thermally stable and contains a lot of conjugated double bonds is particularly preferable. The alignment film may be an inorganic film of syloxane, silsesquioxane, or a derivative thereof. Further, the alignment film may be a film of amorphous carbon hydride referred to as DLC (diamond like carbon), silicon nitride (SiNx), silicon oxide (SiO₂), or silicon carbide (SiC), or a film of a mixture thereof such as an SiCN, SiON, or SiOC film, formed by a dry film formation method such as a sputtering or CVD (chemical vapor deposition) method.

Although, in the first embodiment, both the array board and the opposing board are subjected to the two-step alignment processing, the number of steps or the condition of the alignment processing may differ between the array board and the opposing board. Further, one of the boards is subjected to a plurality of irradiation processing steps with the energy intensity being set lowest in the final step, while the other board is subjected to a single irradiation step. In this case, it is desirable to subject the array board to the plurality of processing steps, and subjecting the opposing board to the single processing step. Further, one of the array board and the opposing board may be treated by the rubbing method, while the other is subjected to a plurality of irradiation processing steps in which the energy intensity is set lowest in the final step. In this case, the higher improving effect of the image quality and reliability can be obtained when the array board is treated by the rubbing method while the opposing board is subjected to the non-contact alignment method conducted in a plurality of steps.

Further, the energy to be irradiated may be X-rays, electron beams, or UV light. When a method of irradiating light such as UV light is employed, the intensity of energy to be irradiated is determined by setting the wavelength longest in the final irradiation step among a plurality of irradiation steps, In the case of light irradiation, it is desirable to use an organic film containing two or more functional groups the structure or bonds of which are changed according to difference in wavelength. For example, a process of performing two-step irradiation, namely a first step of irradiating 193 nm ArF excimer laser light and a second step of irradiating 243 nm KrF excimer laser light is used as an example of the light irradiation method. In this example, main chains are aligned in the first irradiation step so that a certain degree of orientation is thereby established, and then the anisotropy of the bonds contributing to the orientation may be increased in the second irradiation step. Thus, the functional groups which contribute to orientation of liquid crystal but are difficult to align when polymerized as a film can be made possible to use as an alignment film by using in combination therewith a functional group which reacts to the wavelength used in the first irradiation step. Although in the example described above the energy intensity is changed by changing the wavelength of light, it may be changed by changing the angle of incidence of the light.

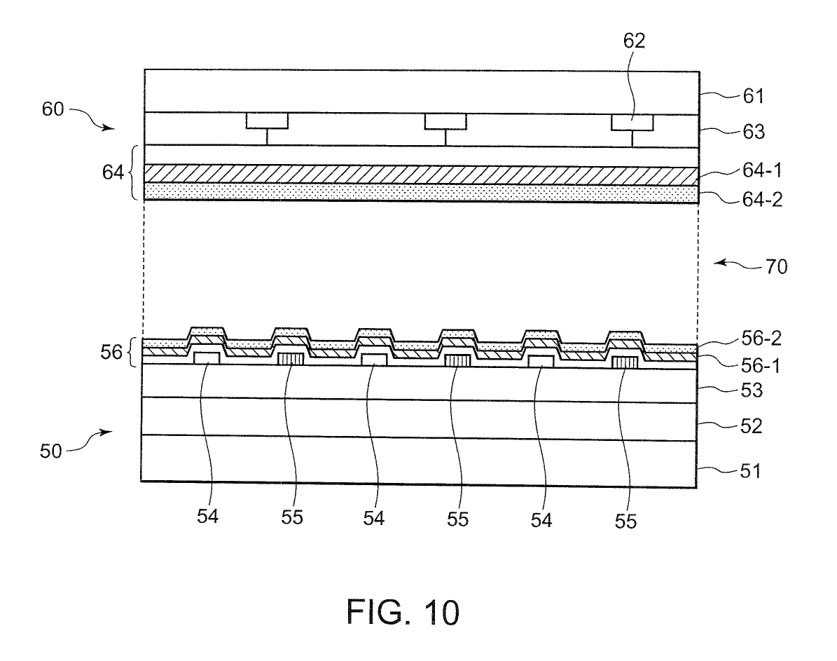

Referring to FIG. 10, principal components of the liquid crystal display device according to the present invention will be described. FIG. 10 shows an array board 50, an opposing board 60, and a liquid crystal layer 70 interposed between the board pair. The array board 50 has a glass board 51, a drive layer 52 including transistors and wirings, and a transparent insulating film 53. There are formed on the transparent insulating film 53, common electrodes 54 and pixel electrodes 55 which are arranged alternately with spaces therebetween. An alignment film 56 is also formed thereon. The opposing board 60 includes a glass board 61, a black matrix 62, a color layer 63, and an alignment film 64. As described above, the alignment film 56 has a quasi-aligned layer 56-1 and a real-aligned layer 56-2, and the alignment film 64 has a quasi-aligned layer 64-1 and a real-aligned layer 64-2. The liquid crystal layer 70 is driven by, for example, a lateral electric field method.

The present invention is applicable for example to those fields requiring a liquid crystal display device having high image quality and high reliability, such as fields of medical equipment and equipment for broadcasting stations. A high quality liquid crystal display device is required in these fields because a slight difference in color tone or a slight afterimage may result in adverse effects. Further, the liquid crystal display device of the present invention is also suitable for use in televisions and other monitors.

What is claimed is:

1. A manufacturing method of a liquid crystal display device comprising a pair of boards opposing to each other and a liquid crystal layer interposed between the pair of boards, the method comprising a step of performing alignment processing on an alignment film formed on the surface of at least one of the pair of boards in contact with the liquid crystal layer,
wherein the alignment processing is performed by irradiating energy having an anisotropy to the alignment film in a plurality of steps while the energy intensity is set lowest in the final irradiation step.

2. The manufacturing method of a liquid crystal display device according to claim 1, wherein in the step of performing the alignment processing, particles extracted from plasma are irradiated to the alignment film.

3. The manufacturing method of a liquid crystal display device according to claim 1, wherein in the step of performing the alignment processing, ion beams having different acceleration energy levels are irradiated.

4. The manufacturing method of a liquid crystal display device according to claim 1, wherein in the step of performing the alignment processing, the energy is irradiated from the same direction in all the plurality of irradiation steps.

5. The manufacturing method of a liquid crystal display device according to claim 1, wherein in the step of performing the alignment processing, the irradiated energy is light.

6. The manufacturing method of a liquid crystal display device according to claim 5, wherein the energy of light irradiated in the step of performing the alignment processing is determined by its wavelength, and the light wavelength is set to be longest in the final irradiation step.

7. A liquid crystal display device comprising a pair of boards facing each other, and a liquid crystal layer interposed between the pair of boards,
wherein the device further comprises an alignment film formed on at least one of the pair of boards, and the alignment film comprises a real-aligned layer located in contact with the liquid crystal layer and having an anisotropy of molecular chains or molecular bonds along the in-plane direction and a quasi-aligned layer located under the real-aligned layer and having a different anisotropy of molecular chains or molecular bonds along the in-plane direction from the anisotropy of the real-aligned layer.

8. The liquid crystal display device according to claim 7, wherein the alignment film contains conjugated double bonds, and the density of conjugated double bonds in the real-aligned layer is lower than the density of conjugated double bonds in the quasi-aligned layer.

9. The liquid crystal display device according to claim 7, wherein the alignment film contains conjugated double bonds, and the anisotropy of the conjugated double bonds of the real-aligned layer along the in-plane direction is higher than that of the quasi-aligned layer.

10. The liquid crystal display device according to claim 7, wherein the alignment film is an organic film.

11. The liquid crystal display device according to claim 7, wherein the alignment film comprising imide bonds.

12. The liquid crystal display device according to claim 7, wherein the liquid crystal layer is driven by a lateral electric field method.
